(19) United States
(12) Patent Application Publication
(10) Pub. No.: US 2009/0178471 A1
(43) Pub. Date: Jul. 16, 2009

(54) Rheometer

(76) Inventor: Reinhard Uphus, Hannover (DE)

Correspondence Address: ROBERT W. BECKER & ASSOCIATES, 707 HIGHWAY 333, SUITE B, TIJERAS, NM, 87059-7507, US

(21) Appl. No.: 12/351,314

(22) Filed: Jan. 9, 2009

(30) Foreign Application Priority Data
Jan. 10, 2008 (DE) 10 2008 003 824.5

(51) Int. Cl. G01N 11/04

(52) U.S. Cl. 73/54.11

(57) ABSTRACT

A rheometer for measuring the viscosity of a fluid, and including an extruder for filling the rheometer. The rotational speed of the extruder is adjustable for filling the rheometer.

The instant application should be granted the priority date of Jan. 10, 2008 the filing date of the corresponding German patent application 10 2008 003 824.5.

### BACKGROUND OF THE INVENTION

The invention relates to a rheometer, which serves for measuring the viscosity of a fluid.

The fluids to be measured here include, for example, rubber mixtures and polymer melts. For polymer melts, for example, rotary viscometers on the couette principle or on the taper plate principle may be used, the last-mentioned principle having the advantage that the shear rate is constant independently of the radius.

Rotary viscometers of this type have in common the fact that a rotating body is driven with a predetermined motive force, and the resistance with which the fluid opposes the rotation is measured. As a result, the shear resistance of the fluid and, consequently, the viscosity can be determined.

A precondition for correct measurement is that the fluid does not come loose from the wall of the rheometer. The rotary body should, in that respect, not “spin”.

In order to prevent spinning, it became known to configure the wall of the rotary body with profiled surfaces, as is the case in Mooney viscometers. This solution has proved appropriate in practice, the implementation of the internal corners there having some disadvantages. When the composition of the fluid is changed, residues of the previous fluid typically remain in the internal corners, so that contamination occurs.

Even in rheometers with profiled surfaces, highly viscous and highly elastic mixtures may slide along the wall. Typically, the viscosity is measured at a predetermined temperature, for example 100° C., and a corresponding blank is introduced which is heated. To balance the temperature, a waiting time of, for example, 1 minute is built into the calculation, although temperature compensation is usually incomplete, since polymers are exceptionally poor conductors of heat.

The operation of the rheometer, on the other hand, gives rise typically to a further temperature increase and shearing action subjecting the material to stress. In that respect, temperature compensation can be usually carried out only after an exceptionally long waiting time.

It has also already become known to connect rheometers on the outlet side of an extruder. An example of a solution of this type may be gathered from DE 33 24 842. In this solution, discontinuities in the fluid stream are to be avoided by means of a specially formed torsion tube with an annular gap. On the other hand, this design is highly complicated, but, even so, highly viscous fluids may come loose from the wall.

The object on which the invention is based, therefore, is to provide a rheometer of the aforementioned type which has a large measuring range, that is to say is suitable even for highly viscous materials, although there is to be the possibility of carrying out continuous measurements.

### SUMMARY OF THE INVENTION

This object is achieved, according to the invention, by means of a rheometer having an extruder for filling the rheometer with fluid, wherein a rotational speed of the extruder for a filling and/or measuring of the rheometer is adjustable, and wherein the rheometer has a conical configuration.

According to the invention, there is provision for the rheometer to be filled by the extruder worm in a directed manner as a function of the material or of the internal pressure of the material. By the material stream filling the rheometer being capable of being set, surprisingly, the tendency of highly viscous fluids to come loose from the wall can be compensated. Where highly viscous fluids are concerned, a higher pressure arises during corresponding volumetric conveyance. Owing to the increase in pressure, the tendency to slide along the wall of the rheometer can be reduced.

On the other hand, an extruder, for example a typical worm extruder, is not a volumetric conveyor. Accordingly, according to the invention, there is provision, for the purpose mentioned, for the rotational speed of an extruder to be increased or, in general, to be made capable of being set, such that the internal pressure of the rheometer is optimized as a function of the measured fluid.

It is particularly beneficial, in this respect, if a pressure sensor detects the internal pressure of the fluid and the rotational speed of the extruder is set as a function of this.

According to the invention, in a beneficial refinement, the heating in the region of the measurement chamber of the rheometer is also detected. Increasing internal friction gives rise to increasing heating. By the rotational speed of the extruder worm being reduced, the mass temperature can preferably be brought to the desired temperature, the pressure in the measurement chamber being capable of being set within wide ranges via the drive for the extruder.

The invention makes it possible to implement a closed system, that is to say one in which the outlet orifice of the measurement chamber is closed when the measurement chamber is filled completely, but also to implement an open system. In the second case, the wide-slot nozzle of the extruder serves as flow resistance, counter to which a pressure is built up.

Surprisingly, according to the invention, wall slip can be avoided completely by the rise or increase in pressure. According to the invention, for this purpose, a particularly high mass pressure is provided by the extruder, thus resulting, with respect to the wall, in a particularly high frictional resistance which prevents any breakaway there.

A further advantage according to the invention is also the reduction in the analysis time, precisely even where highly viscous and elastic polymer melts and rubber mixtures are concerned. The pressure rise allows a good intermixing to reduce the temperature differences, so that the measurement time can be reduced significantly.

An advantageous refinement provides that the rheometer is connected on the outlet side of an extruder worm of the extruder and upstream of an extruder nozzle.

An advantageous refinement provides that an extruder nozzle of the extruder for filling the rheometer can be closed.

An advantageous refinement provides that a pressure sensor is arranged in the region of the rheometer, and the rotational speed of the extruder is adapted to the desired pressure.

An advantageous refinement provides that the main stream of the fluid is conducted through the rheometer on the output side of the extruder.

A further advantageous refinement provides that the rheometer measures the viscosity of the fluid continuously.

An advantageous refinement further provides that an evaluation circuit is connected to the rheometer and, in particular, also to a pressure sensor and, further, preferably to at least one temperature sensor, via which pressure sensor and which temperature sensor the viscosity of the fluid can be detected in comparison with, in particular, the pressure at the rheometer and, in particular, also with the temperature.

A further advantageous refinement provides that the extruder has an extruder nozzle which is designed, in particular, as a flat nozzle and at which the extruded fluid can be seen and can be judged visually.

A further advantageous refinement provides that the rheometer is designed as an oscillating viscometer.

A further advantageous refinement provides that the rheometer is designed as a rotating viscometer.

A further advantageous refinement provides that the rheometer is designed as a rotating viscometer with a superposed oscillation.

A further advantageous refinement provides that the mass pressure of the fluid in the rheometer is set at more than 30 bar, in particular at about 100 bar.

A further advantageous refinement provides that the rheometer has an unprofiled wall surface, and in that the fluid adheres to the wall of the rheometer during measurement.

A further advantageous refinement provides that the diameter of the rotary body substantially corresponds to the diameter of the rheometer chamber.

A further advantageous refinement provides that the rotary body is formed as a double cone, the cone angle of which is larger than 90°, preferably larger than 120°, and in particular approximately 150°.

A further advantageous refinement provides that the rheometer chamber is formed as a flat cylinder and has a height-to-dia-meter ratio of less than 1:2, in particular approximately 1:3.5.

A still further advantageous refinement provides that the diameter of the rheometer chamber and/or of the rotary body is larger than the diameter of the extruder worm.

### BRIEF DESCRIPTION OF THE DRAWINGS

Further advantages, details and features may be gathered from the following description of an exemplary embodiment, with reference to the drawings in which:

FIG. 1 shows a diagrammatic view of an extruder with a rheometer according to the invention; and

FIG. 2 shows a diagrammatic sectional view of the extruder according to FIG. 1 in a different view.

### DESCRIPTION OF SPECIFIC EMBODIMENTS

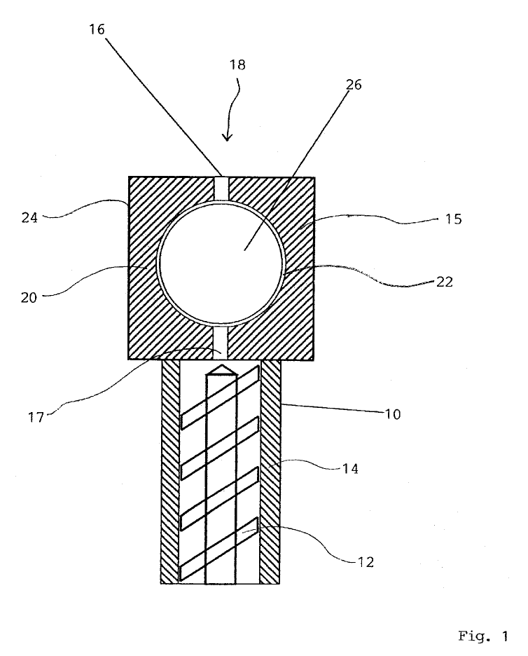

FIG. 1 shows an extruder 10 which supports an extruder worm 12 rotatably in an extruder housing 14. The extruder worm 12 is driven via an extruder motor, not illustrated. Its rotational speed corresponds essentially to the rate of conveyance of the mass extruded by the extruder, although there is no exact proportionality.

Following the extruder 10, an extruder head 15 is provided that can be filled via an inlet orifice 17 and that ends in an extruder nozzle (16).

Between the inlet orifice 17 and the extruder nozzle 16 a flow duct 18 is provided that extends through a rheometer chamber 20 of a rheometer 24. The rheometer 24 comprises a rotary body 26 that is formed as a double cone in the exemplary embodiment illustrated.

As can be seen, only a very narrow nozzle slot or annular gap 22 exists between the outer periphery of the rotary body 26 and the inner wall of the rheometer chamber 20. The nozzle slot, for example, can have a width of 1% to 5% of the diameter of the rheometer chamber.

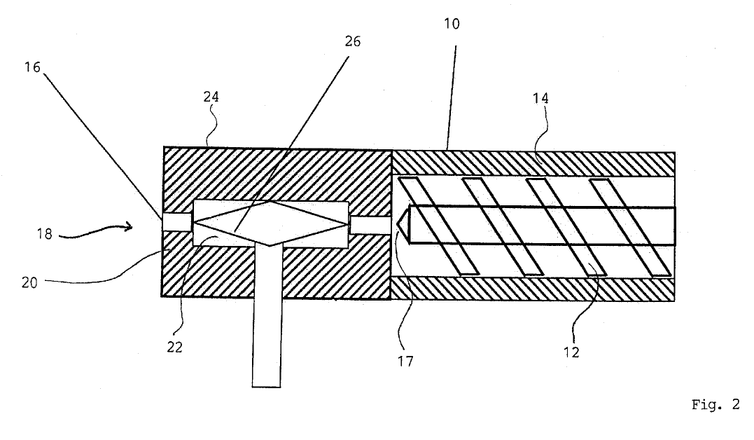

As can be seen from FIG. 2, the flow duct 18 in the region of the rheometer 24 largely also extends above and below the double cone shaped rotary body 26. The flow section provided at this position that basically also extends annularly, is considerably larger than the diameter of the inlet orifice 17 and the nozzle 16. In this respect, the flow speed of the extruded and viscous mass at this position is considerably lower than in the nozzle 16 for example.

According to the invention it is particulary beneficial if the rheometer is arranged immediately adjacent to the outlet of the extruder 10 and if the extruded mass sensed at that position has accordingly the same temperature as in the extruder. Thus, the measurement of the viscosity of the mass is not distorted by different temperatures, whereby it is preferred to additionally provide a thermometer and/or a pressure sensor in the region of the inlet orifice 17 immediately adjacent to the rheometer 24.

In fluidic terms, the rheometer 24 in the flow duct 18 is arranged between the extruder worm 12 and the extruder nozzle 16. The rheometer 24 is designed as a rotary viscometer and operates on the couette principle. The drive mechanism of the rotary body 26 is not shown here and can be effected in a manner known per se, whereby during the rotation of the rotary body, the mass received in the rheometer 24 is subjected to shearing and/or thrust stress. The viscosity, in that respect, arises from the rotational resistance of the rotary body 26.

According to the invention, to fill the rheometer 24, the rotational speed of the extruder worm 12 can be set. Where a highly viscous mass is concerned, the extruder worm 12 operates counter to a comparatively high internal pressure, whereas, with regard to a virtually liquid mass, the internal pressure is correspondingly low. Even for different viscosities, the desired temperature for measurement can be reached quickly and in a flexible way by the setting of the rotational speed of the extruder worm.

According to the invention, owing to the pressure rise in the case of highly viscous masses, the risk of their sliding along the wall in the rheometer 24 is eliminated. Thus, the internal pressure in the rheometer 24 is such that sliding does not occur.

In a modified refinement, the rheometer chamber 20 comprises an additional venting orifice, for example in the region of the axis of the rotary body 26, whereby it shall be understood that it is also possible to provide several venting orifices that are not illustrated here.

For exactly sensing the viscosity of a specific mass, it is also possible to close the extruder nozzle after the filling of the rheometer chamber 20, whereby in this refinement a continuous measurement of course is not possible.

In contrast to this, in the preferred refinement illustrated here, a continuous measurement of the viscosity is possible.

The specification incorporates by reference the disclosure of German priority document 10 2008 003 824.5 filed Jan. 10, 2008.

The present invention is, of course, in no way restricted to the specific disclosure of the specification and drawings, but also encompasses any modifications within the scope of the appended claims.

What I claim is:

1. A rheometer for measuring the viscosity of a fluid, comprising:
an extruder for filling the rheometer with fluid, wherein a rotational speed of said extruder for a filling and/or measuring of said rheometer is adjustable, and wherein said rheometer has a conical configuration.

2. A rheometer according to claim 1, wherein said rheometer is disposed on an outlet side of an extruder worm of said extruder and upstream of an extruder nozzle.

3. A rheometer according to claim 2, wherein said extruder is provided with an extruder nozzle, and wherein said extruder nozzle is closeable for filling said rheometer.

4. A rheometer according to claim 1, wherein a pressure sensor is disposed in the region of said rheometer, and wherein the rotational speed of said extruder is adapted to a desired pressure.

5. A rheometer according to claim 1, wherein at an outlet side of said extruder a main stream of the fluid is conveyed through said rheometer.

6. A rheometer according to claim 1, wherein said rheometer is adapted to continuously measure the viscosity of the fluid.

7. A rheometer according to claim 1, wherein an evaluation circuit is connected to said rheometer and in particular also to a pressure sensor and further preferably to at least one temperature sensor, and wherein via said pressure sensor and said at least one temperature sensor the viscosity of the fluid is adapted to be determined in comparison with, in particular, the pressure at said rheometer and, in particular, also with the temperature.

8. A rheometer according to claim 1, wherein said extruder is provided with an extruder nozzle that is embodied in particular as a flat nozzle and at which extruded fluid is visible and can be visually assessed.

9. A rheometer according to claim 1, wherein said rheometer is embodied as an oscillating viscometer.

10. A rheometer according to claim 1, wherein said rheometer is embodied as a rotating viscometer.

11. A rheometer according to claim 10, wherein said rotating viscometer has a superimposed oscillation.

12. A rheometer according to claim 1, wherein a mass pressure of the fluid in said rheometer is set at greater than 30 bar, in particular at about 100 bar.

13. A rheometer according to claim 1, wherein said rheometer is provided with an unprofiled wall surface, and wherein during a measurement procedure, the fluid adheres to the wall of said rheometer.

14. A rheometer according to claim 1, wherein said rheometer is provided with a rotary body having a diameter that corresponds essentially to a diameter of a chamber of said rheometer.

15. A rheometer according to claim 14, wherein said rotary body is embodied as a double cone, the cone angle of which is greater than 90°, preferably greater than 120°, and in particular being approximately 150°.

16. A rheometer according to claim 1, wherein a chamber of said rheometer has a flat cylindrical configuration with a height-to-diameter ratio of less than 1:2, in particular, less than 1:3.5.

17. A rheometer according to claim 1, wherein said rheometer is provided with a rotary body, and wherein a diameter of at least one of a chamber of said rheometer and said rotary body is greater than a diameter of an extruder worm of said extruder.
